(19) United States
(12) Patent Application Publication
(10) Pub. No.: US 2008/0001047 A1
(43) Pub. Date: Jan. 3, 2008

(54) Suction Cup Mount for Axial Fan

(76) Inventor: Kyle Michael Madison, Salisbury, NC (US)

Correspondence Address: KYLE MICHAEL MADISON, 914 NORTH MAIN STREET, SALISBURY, NC, 28144, US

(21) Appl. No.: 11/427,844

(22) Filed: Jun. 30, 2006

(51) Int. Cl. F16B 47/00

(52) U.S. Cl. 248/205.5

(57) ABSTRACT

The invention is a suction cup mount that attaches an axial type fan to a non-porous surface utilizing a total of four suction cups arraigned in a fashion that two of the suction cups, the primary load bearing suction cups, provide the majority of the holding force for the axial fan housing. The remaining two suction cups, the safety lanyard suction cups, provide a back-up in order to hold the axial fan housing in the event of a failure of the primary load bearing suction cups. The safety lanyard suction cups also allow a user of the axial fan to position the fan thereby varying the direction of the air output of the axial fan.

### BACKGROUND

1. Field of Invention

The invention relates to a suction cup mount for an axial type fan housing suitable for any non-porous surface. A brief description of the invention has been disclosed in provisional patent application No. 60/696,281 dated 1 Jul. 2005.

2. Description of Prior Art

In various applications a fan is desired for personal cooing on the inside of an automobile, truck, boat or airplane. Most all vehicles have some kind of non-porous surface like a window or a non-porous wall to which a fan with a suitable suction cup mount can be affixed.

The principle object of the invention is to provide a primary means of attaching an axial fan housing to any non-porous surface.

A further object is to provide a configuration that would safely support the axial fan housing in the event of a suction cup failure or failures resulting in the fan's housing falling and possibly causing personal injury.

A further object is to provide a means of adjusting the direction of the airflow emitting from the axial fan's impeller.

One best example of prior art is from a generic personal fan manufactured in China and advertised over the Internet that utilizes a single suction cup at its base. This type of mount is not designed for an axial type fan and does not provide any back-up means to prevent personal injury in case of a failure of the single suction cup mount at the fan's base. In the case of the single suction cup failure, the fan would fall because there is no mounting back-up to catch the fan housing which could result in possible personal injury.

Yet another example is a typical personal cooling fan like would be mounted on the inside of a truck cab window. Personal cooling fans of this design normally utilize a solid metal bracket to which two or more suction cups are affixed for attaching the fan to the inside of the vehicle's windshield. Since the suction cups are all attached to the same bracket the entire weight of the fan is being supported by the suction cups attached to the bracket. This typical design provides no safety back-up means and in the event of a multiple suction cup failure, the fan could fall possibly causing personal injury. In addition, no prior art was discovered that showed this configuration used to mount an axial type of fan housing.

Yet another example of prior art is described in U.S. Pat. No. 4,850,804, which depicts a fan that is not of an axial type and utilizes a clamp type mount. This type of mount could not be used in the same way that a suction cup mount would be used on a non-porous surface and neither provides for a safety back-up mounting means.

With the invention, two of the suction cup mounts bears the vast majority of the axial fan housing's weight and two are attached to the fan's housing by means of safety lanyards that act as a back-up to the primary load bearing suction cups. The safety lanyards suction cups are also used to position the housing of the fan thereby adjusting the direction of the fan's air output.

### OBJECTS AND ADVANTAGES

Some of the objects and advantages of the invention are:

(a) To provide a means to mount an axial fan's housing to a non-porous surface most commonly in some kind of vehicle.

(b) To provide a means to support the axial fan's housing in the event of a failure of the primary load bearing part of the mount in order to prevent personal injury.

(c) To provide a means to adjust the direction of the airflow from the fan by shifting the axial fan's housing about the axis of the primary load bearing part of the mount and anchoring the axial fan with the safety lanyard part of the invention.

### DRAWINGS FIGURES

FIG. 1 Shows a front view of the invention.

FIG. 2 Shows an exploded view of the invention less the safety lanyards, the safety lanyard suction cups, and including the ring terminals of the safety lanyards.

FIG. 3 Depicts a side view of the invention demonstrating how the safety lanyard suction cups are used to position the output of the axial fan.

### REFERENCE NUMERALS IN DRAWINGS

10 axial fan housing
12 primary load bearing suction cup
14 safety lanyard
16 safety lanyard suction cup
18 primary load bearing mount machine screw
20 primary load bearing mount standoff
22 safety lanyard mount stud
24 safety lanyard mount nut
26 safety lanyard clamp
28 safety lanyard ring terminal

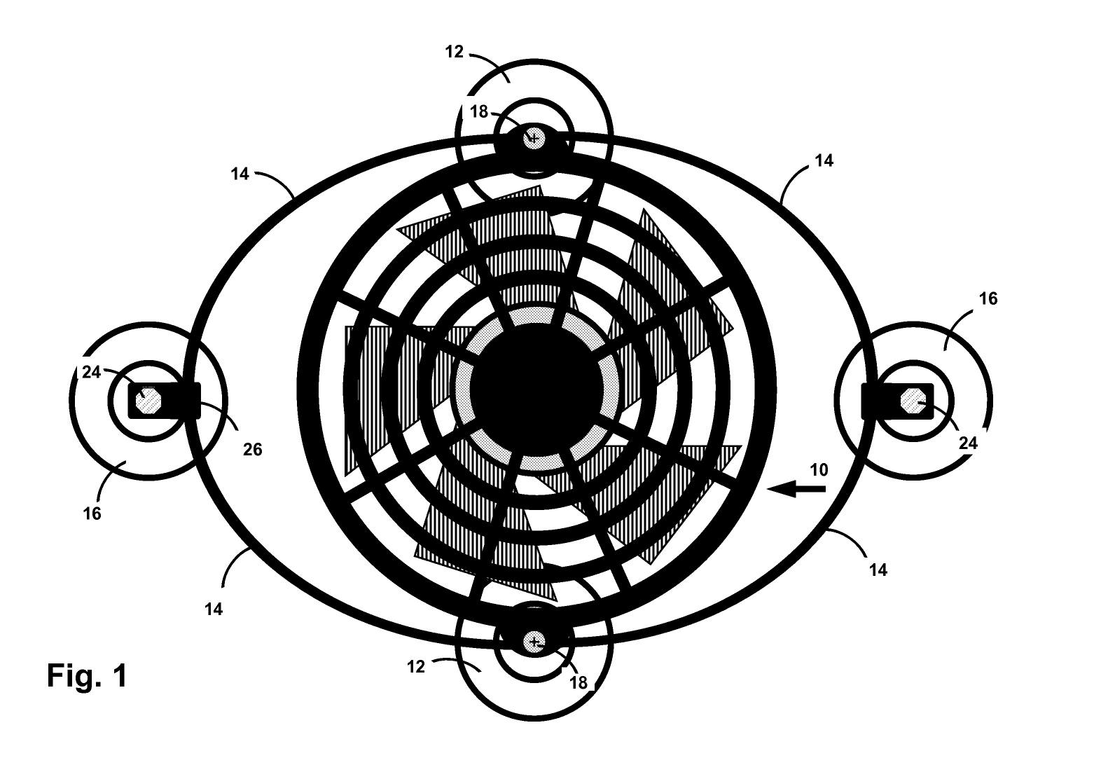

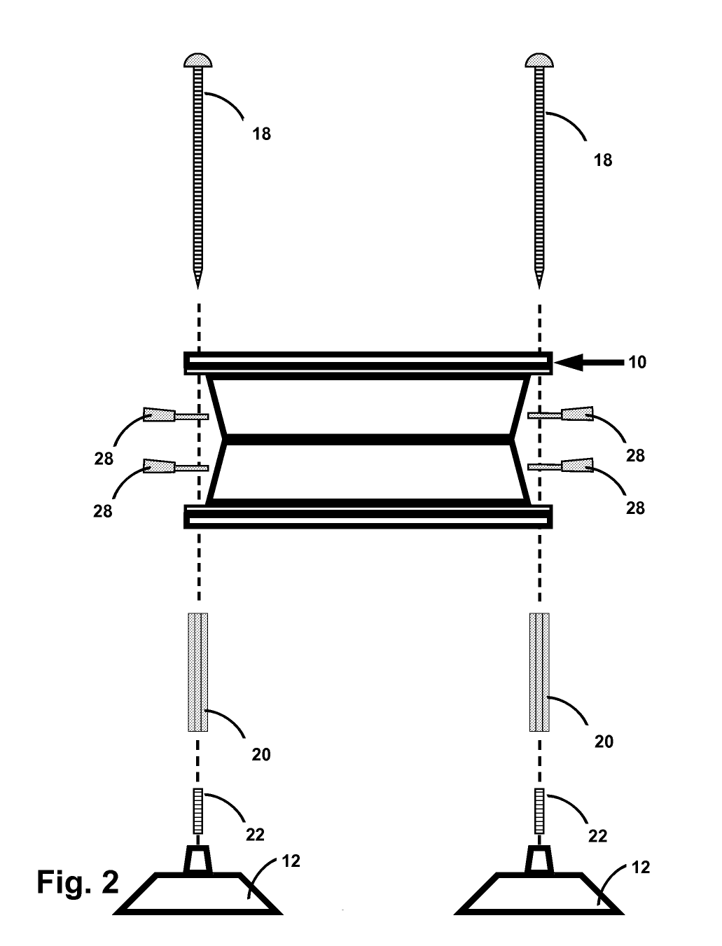

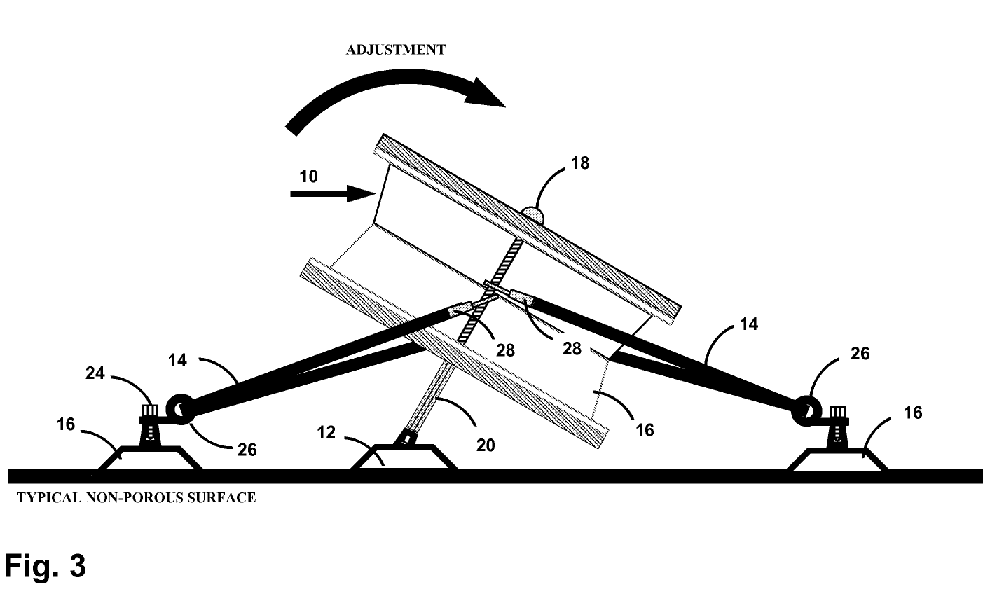

### DETAILED DESCRIPTION OF PREFERRED EMBODIMENT—FIGS. 1-3

The invention comprises an arraignment of suction cups that allow for the attachment of an axial type fan housing 10 to any non-porous surface, typically glass, Plexiglas, Lexan, fiberglass, sheet metal, etcetera.

The primary load bearing portion of the invention is comprised of two machine screws 18, which are inserted through the axial fan's housing and threaded into two standoffs 20. The machine screws 18 the standoffs 20 and the studs 22 serve as connection points between the axial fan housing 10 and the primary load bearing suction cups 12. The machine screws 18 and the standoffs 20 assembled together serve as a means to hold the various parts of the fan housing together. The machine screws also serve as an attachment point between the fan's housing 10 and the safety lanyards 14 by means of the safety lanyard's ring terminals 28 and the safety lanyard's two suction cups 16.

The safety lanyard suction cups 16 are attached to the safety lanyard clamps 26 by means of two studs 22 and two nuts 24. The safety lanyards 14 are mechanically affixed with ring terminals 28 on all ends and the safety lanyards are passed through the safety lanyard clamps 26. The safety lanyards 14 are attached to the fan housing 10 by means of the machine screws 18 and the safety lanyard ring terminals 28.

### SUMMARY, RAMIFICATIONS, AND SCOPE

The invention, suction cup mount for axial fan, provides a secure and safe way to mount an axial type fan housing to a non-porous surface. The primary load bearing section of the mount supports the majority of the weight of the axial fan's housing. The safety lanyard portion of the invention normally supports very little of the axial fan housing's weight, so that there is very little pulling force on the safety lanyard suction cups themselves, therefore they are more likely than the primary load bearing suction cups to stay affixed to the non-porous mounting surface.

With both the primary load bearing suction cups affixed to the non-porous surface and the safety lanyard suction cups affixed, the axial fan's housing is securely and safely attached to the non-porous surface. In the event that the primary load bearing suction cups loose their attachment, the safety lanyard suction cups will prevent the axial fan's housing from falling and possibly causing personal injury.
it provides a means of safely mounting an axial type fan housing to a non-porous surface.
it provides a back-up means of support so that in the event of a failure of the primary load bearing suction cups, the axial fan's housing will not become completely detached from the non-porous surface.
it is designed so that the safety lanyard suction cups portion of the invention also serves as a positioning device to direct the air output of the axial fan.

Although the description above contains many specificities, these should not be construed as limiting the scope of the invention but as merely providing illustrations of some of the presently preferred embodiments of this invention. For example, the suction cup mount as described could be used on a fan other than that of an axial type. The axial type fan was used in this embodiment because of its compact design and its suitability when operating in close proximity with electronic equipment. Thus, the scope of the invention should be determined by the appended claims and their legal equivalents, rather than by the examples given.

I claim:

1. A mount of the suction cup style able to securely mount an axial type fan housing to a non-porous surface.

2. A mount of the suction cup style wherein the mount has a safety back-up design in that one portion holds the axial fan at a lesser pulling force than the primary load bearing part of the suction cup mount.

3. A mount of the suction cup style that has the ability to position the axial fan in various positions by swiveling the fan's housing about the primary load bearing portion's axis and anchoring the axial fan's housing with the safety lanyard suction cups.
